(19) United States
(12) Patent Application Publication
(10) Pub. No.: US 2005/0234725 A1
(43) Pub. Date: Oct. 20, 2005

(54) Method and system for flexible usage of a graphical call flow builder

(75) Inventors: Ciprian Agapi, Lake Worth, FL (US); Felipe Gomez, Weston, FL (US); James R. Lewis, Delray Beach, FL (US); Vanessa V. Michelini, Boca Raton, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, ARMONK, NY (US)

(21) Appl. No.: 10/828,040

(22) Filed: Apr. 20, 2004

(51) Int. Cl. G10L 13/08

(52) U.S. Cl. 704/260

(57) ABSTRACT

A method (10) of developing call flows can simply include a determination (12) whether an alternative speech field is filled. If the alternative speech field is not filled, then the description text is used (16) in a description field as a default for text for speech output. The description field can be presented graphically and in a properties sheet for speech output objects. If an optional speech text field is filled in the properties sheet, then the description text in the description field can be replaced (14) with the contents of the optional speech text field for text to speech output. The contents of the optional speech text field (32) can be represented as a flyover (23) graphically when pointing to the graphical object. Optionally, the description field (34) and the optional speech text field can be edited on a single graphical user interface (20).

### BACKGROUND OF THE INVENTION

1. Technical Field

This invention relates to the field of call flow editors and builders, and more particularly to a method and system for easily using a call flow editor for both higher level and lower level development of call flows.

2. Description of the Related Art

When developing call flows, some designers prefer to use high-level descriptions of objects while others prefer to type the exact speech that they desire the system to produce for system messages and prompts. No existing editor enables the use of both styles in a single editor. Use of settings on a preferences page can possibly be used as an alternative, but such an option makes it difficult to change the graphical layout so it continues to look good and easy to use when switching from high-level to detailed styles.

### SUMMARY OF THE INVENTION

Embodiments in accordance with the invention can enable a method and system for using the description field (presented graphically and in a properties sheet for speech output objects such as messages and prompts) as the default field for a text for speech output. The properties sheet can also include an optional speech text field which, if filled, replaces the description text as the field defined to contain the text for speech output. If filled, the optional speech text can appear in a flyover when pointing to the graphical object.

In a first aspect of the invention, a method of developing call flows can include the steps of using description text in a description field as a default for text to speech output and presenting the description field graphically and in a properties sheet for speech output objects. If an optional speech text field is filled in the properties sheet, the method can further include the step of replacing the description text in the description field with the contents of the optional speech text field for text to speech output. The method can also include the step of representing the contents of the optional speech text field as a flyover graphically when pointing to the graphical object.

Note, the description field can be used in a high level flow description and the optional speech text field can be used for a detailed level flow description. Optionally, the description field and the optional speech text field can be edited on a single graphical user interface.

In a second aspect of the invention, a call flow editor system can include a display and a processor coupled to the display. The processor can be programmed to use description text in a description field as a default for text to speech output and present the description field graphically and in a properties sheet for speech output objects. If an optional speech text field is filled in the properties sheet, the processor can further be programmed to replace the description text in the description field with the contents of the optional speech text field for text to speech output. The processor can further be programmed to represent the contents of the optional speech text field as a flyover graphically when pointing to the graphical object and also to enable editing of both the description field and the optional speech text field on a single graphical user interface.

In a third aspect of the invention, a computer program has a plurality of code sections executable by a machine for causing the machine to perform certain steps as described in the method and systems outlined in the first and second aspects above.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a high-level flow chart of a method of developing call flows in accordance with an embodiment of the present invention.

FIG. 2 is a call flow illustrating both a high level flow and a properties sheet with text for an optional speech text field appearing as a flyover for a message object that has the description “Intro” in accordance with an embodiment of the present invention.

### DETAILED DESCRIPTION OF THE INVENTION

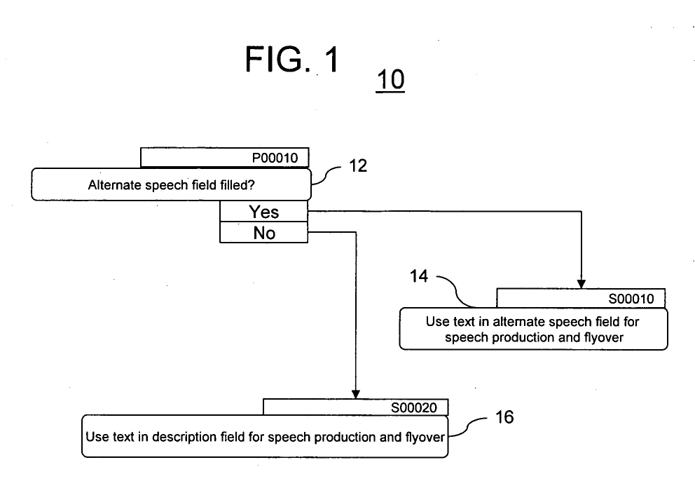

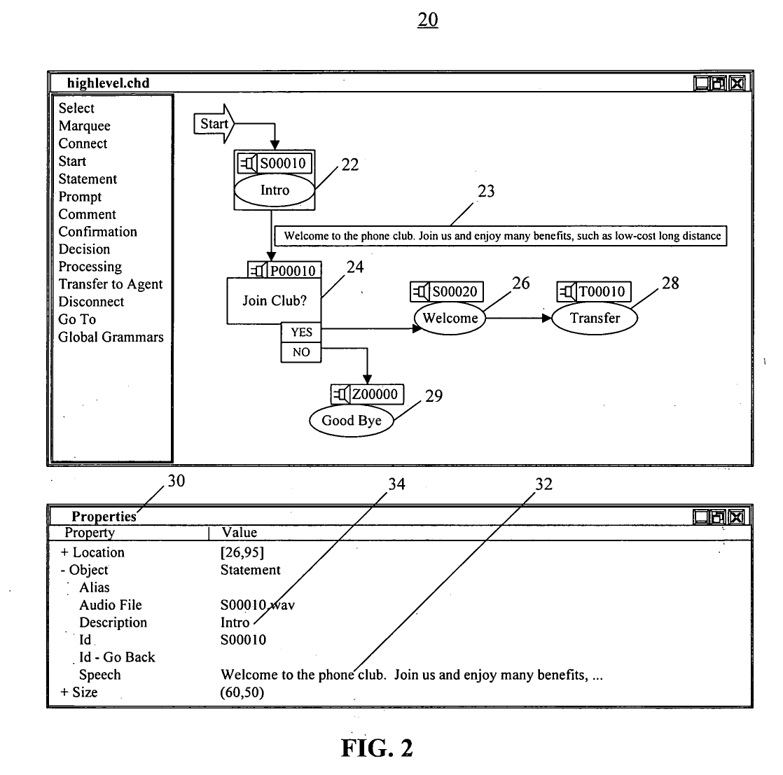

Referring to FIG. 1, a high-level flow chart of a method 10 of developing call flows is shown. The flow chart shows the decision that is made for each object that defines any speech production, such as messages or prompts created using a Call Flow Builder and further illustrates how the detailed style in which the text in the fields can be verbose. The method 10 can simply include a determination whether an alternative speech field is filled at decision block 12. If the alternative speech field is not filled, then the method 10 at step 16 uses description text in a description field as a default for text for speech output. The description field can be presented graphically and in a properties sheet for speech output objects. If an optional speech text field is filled in the properties sheet, then the method 10 can further include the step 14 of replacing the description text in the description field with the contents of the optional speech text field for text to speech output. The step 14 can also include the step of representing the contents of the optional speech text field as a flyover graphically when pointing to the graphical object. Note, the description field can be used in a high level flow description and the optional speech text field can be used for a detailed level flow description. Optionally, the description field and the optional speech text field can be edited on a single graphical user interface as will be further illustrated with respect to FIG. 2.

In another aspect of the invention as illustrated in the sample call flow 20 of FIG. 2, a description field 22 or 34 (presented graphically (22) and in text (34) in a properties sheet 30 for speech output objects such as messages and prompts) as the default field for the text for speech output. The properties sheet 30 also includes an optional speech text field 32 which, if filled, replaces the description text as the field defined to contain the text for speech output. If filled, the optional speech text appears in a flyover 23 when pointing to the graphical object. This particular arrangement enables the use of two different development styles, namely a high-level description style favored by “logic” designers or developer and a detailed prompt text style favored by user interface designers or developers. With this call flow builder it is easy for one developer to produce a high-level view (illustrating the logic) of the flowchart, then hand it off to a developer whose primary skill is in writing detailed prompts. As the second developer writes the detailed prompts, they can replace the high-level descriptions in any code generated from the call flow. As shown, the sample call flow continues with asking whether the caller wants to join the club at step 24. If the caller answers in the affirmative, the call flow provides a welcome message at step 26 and transfers the caller at step 28. If the caller does not want join the club, a “goodbye” message is given at step 29.

The call flow builder arranged in this fashion is dynamic in enabling both terse and verbose language during the lifecycle of a project. It is suitable to use the terse language at the beginning of a design where a schematic approach is needed as a communication token to “brainstorm” the ideas of a team of people. At this stage, most modifications are made and the logic is crystallized by the developers. Due to the “churn” that occurs during this stage of development, it's often not appropriate to invest a lot of time in crafting the exact wording of prompts and messages. Once this “churn” is somewhat stabilized, other iterations can be made with the second verbose language, which can make its way into the call flow or into another file (a file which serves the purpose of providing the list of phrases to record). These second iterations serve the purpose of user interface design. This dichotomy of representation of an application can be a problem in many projects, where it was hard to track the logic and language among two different files. In this embodiment, a Call Flow Builder keeps the two language representations of an application together. The “logic” developers and the “UI design” developers now work from the same “view” of an application, and all the necessary files (including the code) can be subsequently generated from it.

Referring once again to FIG. 2, if code were generated from call flow diagram 20, the text from the optional speech field 32 would be used as the alternate text for the audio tag, as shown below:

<audio src=“S00010.wav”>
Welcome to the phone club. Join us and enjoy many benefits,
such as low-cost
long distance!
</audio>

Otherwise, the generated code would have used the description text, as shown below:

<audio src=“S00010.wav”>
Intro
</audio>

It should be understood that the present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of developing call flows, comprising the steps of:
using description text in a description field as a default for text to speech output;
presenting the description field graphically and in a properties sheet for speech output objects; and
if an optional speech text field is filled in the properties sheet, replacing the description text in the description field with the contents of the optional speech text field for text to speech output.

2. The method of claim 1, wherein the method further comprises the step of representing the contents of the optional speech text field as a flyover graphically when pointing to the graphical object.

3. The method of claim 1, wherein the description field is used in a high level flow description and the optional speech text field is used for a detailed level flow description.

4. The method of claim 1, wherein the method further comprises the step of editing both the description field and the optional speech text field on a single graphical user interface.

5. A call flow editor system, comprising:
a display; and
a processor coupled to the display programmed to:
use description text in a description field as a default for text to speech output;
present the description field graphically and in a properties sheet for speech output objects; and
if an optional speech text field is filled in the properties sheet, replace the description text in the description field with the contents of the optional speech text field for text to speech output.

6. The system of claim 5, wherein the processor is further programmed to represent the contents of the optional speech text field as a flyover graphically when pointing to the graphical object.

7. The system of claim 5, wherein the description field is used in a high level flow description and the optional speech text field is used for a detailed level flow description.

8. The system of claim 5, wherein the processor is further programmed to enable editing of both the description field and the optional speech text field on a single graphical user interface.

9. A machine-readable storage, having stored thereon a computer program having a plurality of code sections executable by a machine for causing the machine to perform the steps of using description text in a description field as a default for text to speech output, presenting the description field graphically and in a properties sheet for speech output objects, and if an optional speech text field is filled in the properties sheet, replacing the description text in the description field with the contents of the optional speech text field for text to speech output.

10. The machine-readable storage of claim 9, wherein the machine-readable storage is further programmed to represent the contents of the optional speech text field as a flyover graphically when pointing to the graphical object.

11. The machine-readable storage of claim 9, wherein the machine-readable storage is further programmed to enable editing of both the description field and the optional speech text field on a single graphical user interface.
